(19) United States
(12) Patent Application Publication
(10) Pub. No.: US 2012/0038144 A1
(43) Pub. Date: Feb. 16, 2012

(54) Fittings for Electrical Conduits

(75) Inventors: Vinayak Chavan, Pune (IN); Ashok Sathyanarayana, Pune (IN)

(73) Assignee: SIGMA ELECTRIC MANUFACTURING CORPORATION, Garner, NC (US)

(21) Appl. No.: 12/856,577

(22) Filed: Aug. 13, 2010

(51) Int. Cl. F16L 21/00

(52) U.S. Cl. 285/31

(57) ABSTRACT

An electrical conduit fitting comprising a metallic housing and a plurality of apertures in wall of the metallic housing. The plurality of apertures are configured to reduce weight of the fitting. The fitting also comprises a holding arrangement such as set-screw, locknut, screw-in connection, clamp etc. at each extremity of the metallic housing.

### FIELD OF THE INVENTION

The present invention relates to apparatus for coupling electrical conduits. More particularly, it relates to apparatus for coupling together conduits and apparatus for coupling conduits to enclosures. For example, conduit can be electrical metallic tubing (EMT) conduit, flexible metallic conduit (FMC) conduit or any other appropriate conduit. Also as an example, the enclosure can be an electrical junction box. Related methods are also included.

### BACKGROUND OF THE INVENTION

Conduits are often used to provide protection for electrical conductors in wiring of residential, commercial and industrial premises. Depending upon the application, these conduits can protect the conductors from impact, moisture, chemical vapors and like. The conduits can also offer additional benefit of ease of changing electrical conductors, e.g., existing conductors can be withdrawn and new conductors installed.

The conduits made from metal are often used. Merely as examples, electrical metallic tubing (EMT) conduits and flexible metallic conduits (FMC) have been popular. Conduits made from other materials are also often used, for example, non-metallic conduits.

During installation of conduits, it is often required to couple two conduits together, for example, if the total span is more than the length of a single conduit. The conduit is also often required to be coupled to an enclosure such as electrical junction box. To facilitate such coupling, conduit fittings are often used. Examples of conduit fittings include set-screw coupler, set-screw connector, compression fit coupler/connector etc.

The cost of conduit installation can be high due to the cost of fitting and labor. It thus becomes desirable to provide coupling techniques which can reduce cost of fitting, enhance efficiency of installation, enhance quality of installation and like.

### SUMMARY OF THE INVENTION

It is an object of the present invention to provide coupling apparatus for electrical conduits. In an embodiment, an improved coupling apparatus is provided to couple together conduits. In an alternative embodiment, an improved coupling apparatus is provided to couple conduit to enclosure such as electrical junction box. Related methods are also included.

According to a specific embodiment, the present invention provides an electrical conduit fitting apparatus comprising a metallic housing and a plurality of apertures in wall of the housing. The plurality of apertures are configured to reduce weight of the fitting and thus reduce the amount of material required to make the housing. Moreover, the fitting apparatus comprises a holding arrangement (e.g., set-screw, locknut, clamp etc.) at each extremity of the metallic housing.

Various advantages and/or benefits may be obtained from techniques of the present invention. For example, the fittings are often made from metal. The apparatus according to the present invention can require lesser amount of metal to make the fitting, thereby saving valuable natural resources as well as reducing cost of the fitting. As another example, the apparatus can provide for better grip on the outer surface for the operator to facilitate ease of installation. As yet another example, the apparatus can provide better see-through to facilitate ease of installation.

These and various other objects, features, advantages, and benefits of the present invention can be more fully appreciated with reference to the detailed description and accompanying drawings that follow.

### BRIEF DESCRIPTION OF THE DRAWINGS

Embodiments of the invention are illustrated in the figures of the accompanying drawings. These figures are merely examples which should not unduly limit the scope of the invention. Persons of ordinary skill in the art can derive many alternatives, variations and modifications within the scope of the invention described herein.

FIG. 1 illustrates an exemplary schematic of certain conventional set-screw fitting for coupling conduits together.

FIG. 2 illustrates an exemplary schematic of certain conventional set-screw fitting for coupling conduit to enclosure.

FIG. 3 illustrates exemplary schematics of certain conventional compression fittings for coupling conduits together and for coupling conduit to enclosure.

FIG. 4 illustrates an exemplary schematic of improved set-screw fitting for coupling conduits together, according to an embodiment of the present invention.

FIG. 5 illustrates an exemplary schematic of improved set-screw fitting for coupling conduit to enclosure, according to an alternative embodiment of the present invention.

FIG. 6 illustrates an exemplary schematic of improved fitting including compression fit arrangement, according to yet an alternative embodiment of the present invention.

FIG. 7 illustrates an exemplary schematic of improved fitting including compression fit arrangement, according to further alternative embodiment of the present invention.

FIG. 8 illustrates an exemplary schematic of improved fitting including compression fit arrangement, according to further alternative embodiment of the present invention.

### DETAILED DESCRIPTION OF THE INVENTION

The present invention relates to apparatus (called as “fitting”) for coupling electrical conduits. More particularly, it relates to apparatus for coupling together conduits and apparatus for coupling conduits to enclosures. For example, conduits can be electrical metallic tubing (EMT) conduits, flexible metallic conduits (FMC) or any other appropriate conduit. Also as an example, the enclosure can be an electrical junction box. Related methods are also included.

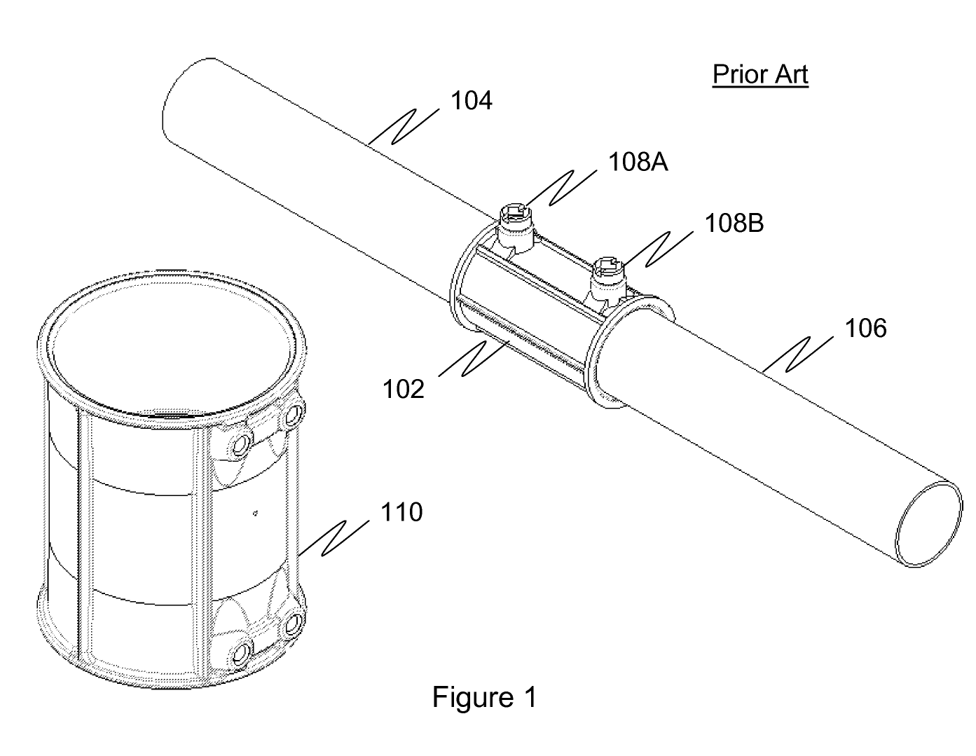

FIG. 1 illustrates an exemplary schematic of certain conventional fitting used to couple conduits together. As shown therein, the fitting (102) comprises a hollow cylindrical metallic housing and utilizes set-screw arrangement at either end of the housing. The conduits to be coupled (104, 106) are inserted into either side of the cylindrical housing and set-screws (108A, 108B) are then tightened on the inserted conduits. Also shown in FIG. 1 is an alternative conventional fitting (110) utilizing multiple set-screws at either end.

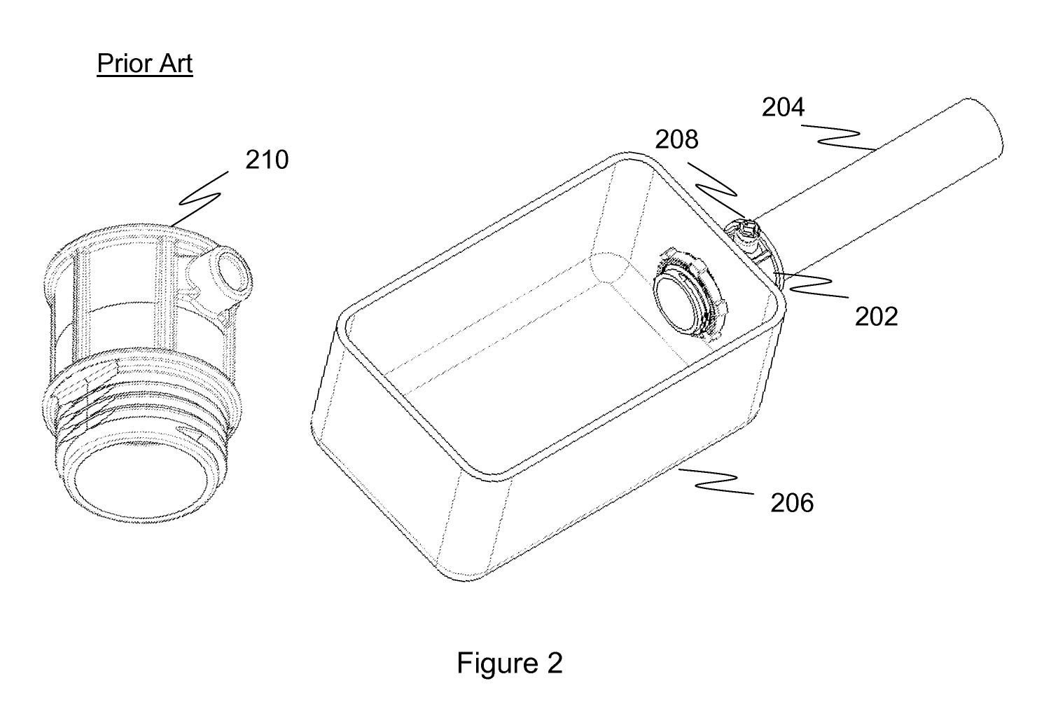

FIG. 2 illustrates an exemplary schematic of certain conventional fitting used to couple conduit to junction box. As shown therein, the fitting (shown separated from the conduit and junction box assembly at 210) comprises a hollow cylindrical metallic housing (202) which utilizes a threading and a locknut arrangement at one end and one or more set-screws at the other end. The threaded end of the fitting can be inserted in the junction box (206) and the locknut can then be tightened on the threads. The conduit (204) can be inserted into the other side of the fitting and the one or more set-screws (208) can then be tightened on the inserted conduit.

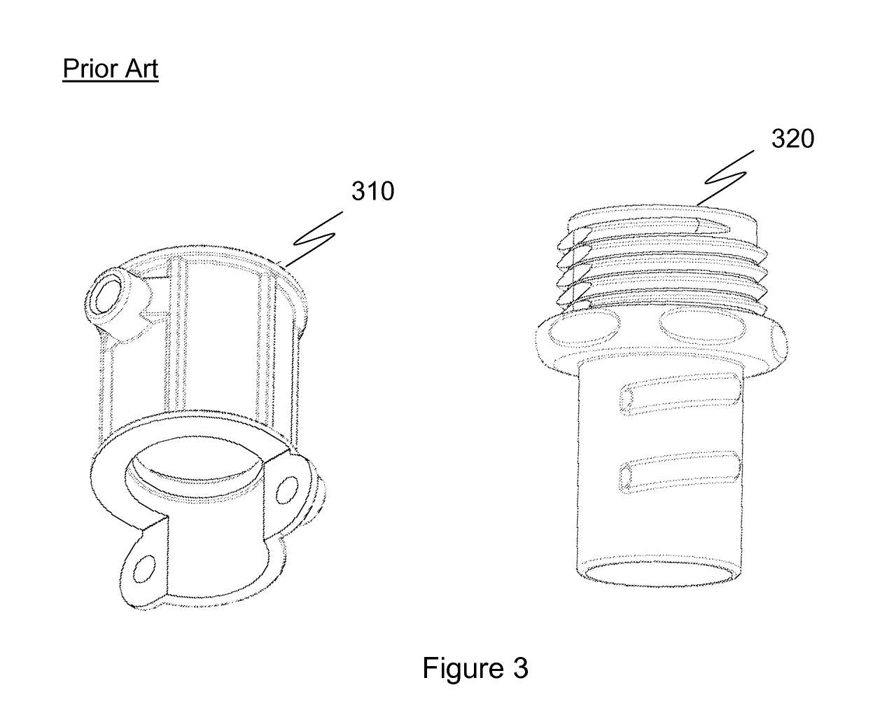

Schematics of certain more conventional fittings are illustrated in FIG. 3. More particularly, the fitting (310) utilizes set-screw arrangement at one end and a compression fit arrangement at the other end. For example, the compression fit arrangement utilizes a clamp (not shown in the Figure) fitted on the conduit after the conduit is inserted in the fitting. The fitting (320) utilizes screw-in connection arrangement at one end and threading and locknut arrangement at the other end.

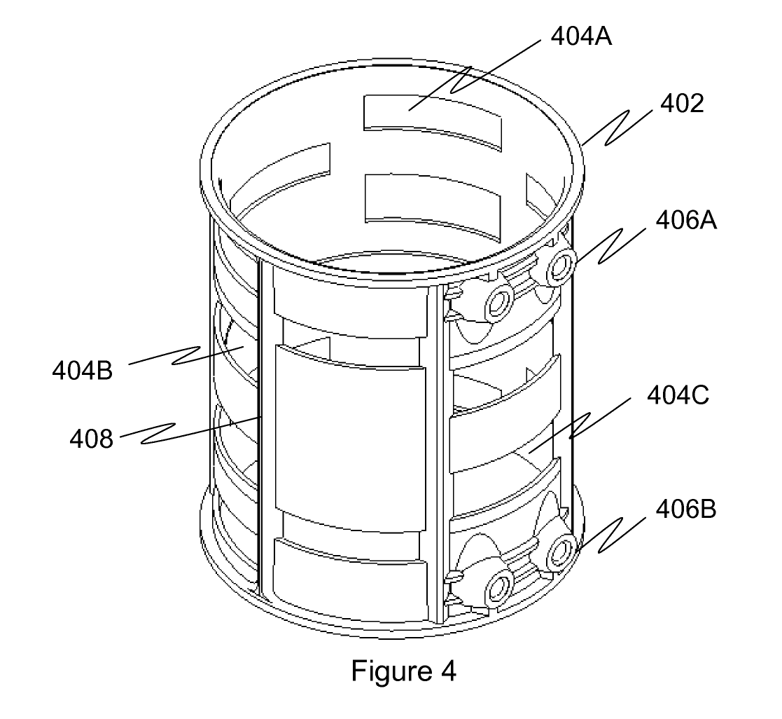

FIG. 4 illustrates an exemplary schematic of a fitting used to couple together conduits, according to an embodiment of the present invention. As shown therein, the fitting in this embodiment of the present invention comprises a hollow cylindrical metallic housing (402) which can receive conduits into either ends. A plurality of apertures (404A, 404B, 404C etc.) are provided in the cylindrical surface of the housing (wall of the housing). In a specific embodiment, the total area of the plurality of apertures is about 40% of the outer housing area. In an alternative specific embodiment, the total area of the plurality of apertures is 10 to 60% of the outer housing area.

As also shown in FIG. 4, the fitting comprises one or more threaded holes (406A, 406B etc.) at either ends to receive one or more set-screws to be tightened on the conduits after they are inserted into the fitting. In a specific embodiment, longitudinal ridges (408) can also be provided on the fitting.

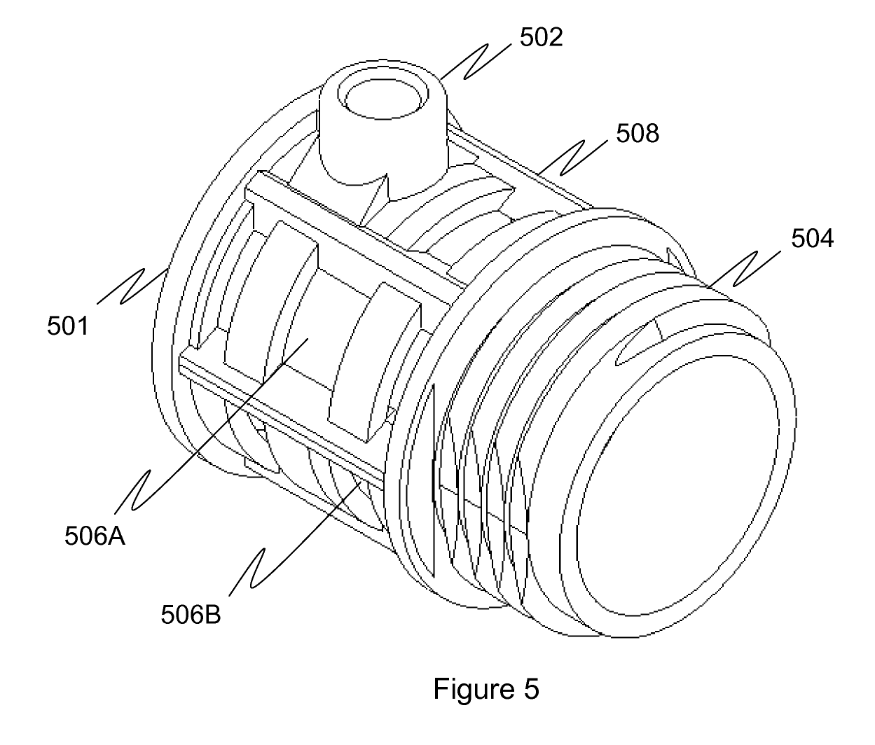

FIG. 5 illustrates an exemplary schematic of a fitting used to couple conduit to junction box, according to an alternative embodiment of the present invention. As shown therein, the fitting in this embodiment comprises a hollow cylindrical metallic housing (501). The housing is able to receive the conduit into one end and comprises one or more threaded holes (502) at that end to receive one or more set-screws to be tightened on the conduit inserted into the cylindrical housing. The other end of the housing exhibits threading (504) to receive a locknut on it. A plurality of apertures (506A, 506B etc.) are provided in the cylindrical surface of the housing (wall of the housing). In a specific embodiment, the total area of the plurality of apertures is about 40% of the outer housing area. In an alternative specific embodiment, the total area of the plurality of apertures is 10 to 60% of the outer housing area. In a specific embodiment, longitudinal ridges (508) can also be provided on the housing.

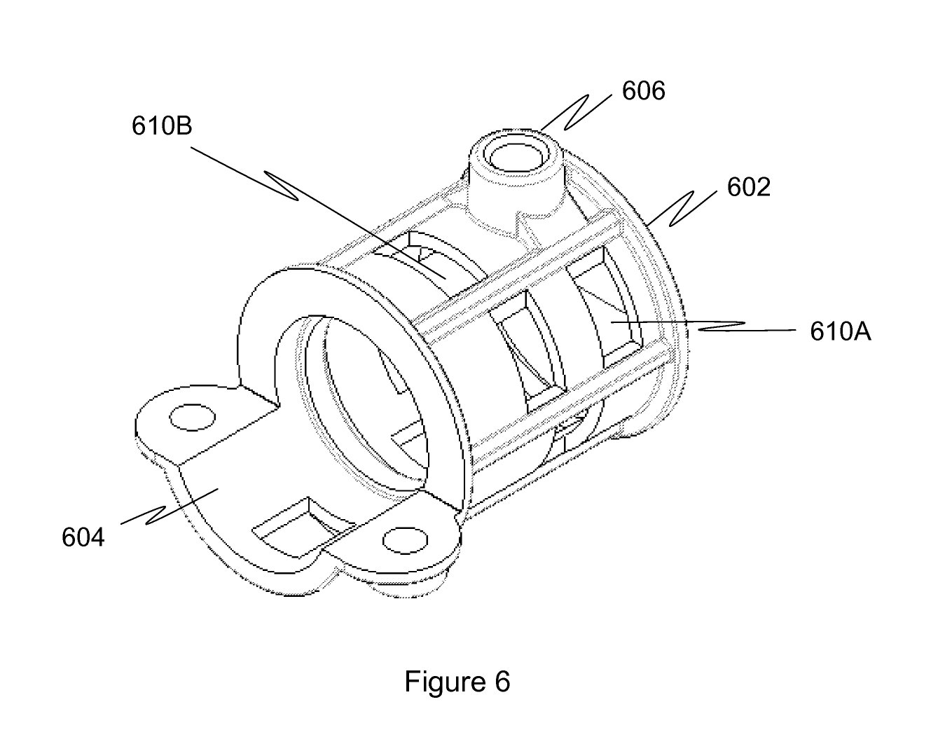

FIG. 6 illustrates an exemplary schematic of a fitting used to couple together conduits, according to yet an alternative embodiment of the present invention. As shown therein, the fitting in this embodiment of the present invention comprises a hollow cylindrical metallic housing (602) which has compression fit arrangement at one end (604) and set-screw arrangement at the other end (606). Moreover, a plurality of apertures (610A, 610B etc.) are provided in the cylindrical surface of the housing (wall of the housing).

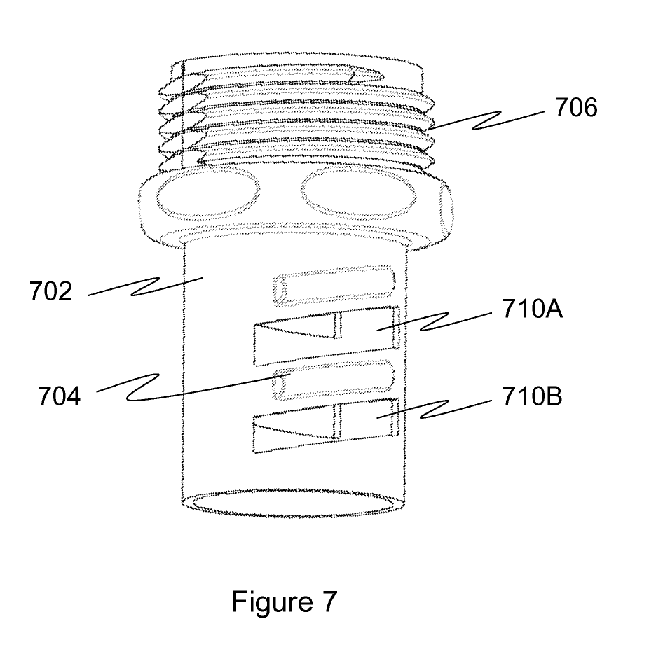

FIG. 7 illustrates an exemplary schematic of a fitting used to couple conduit to junction box, according to further alternative embodiment of the present invention. As shown therein, the fitting in this embodiment comprises a hollow cylindrical metallic housing (702) which has screw-in connection arrangement at one end (704) and locknut arrangement at the other end (706). Moreover, a plurality of apertures (710A, 710B etc.) are provided in the cylindrical surface of the housing (wall of the housing).

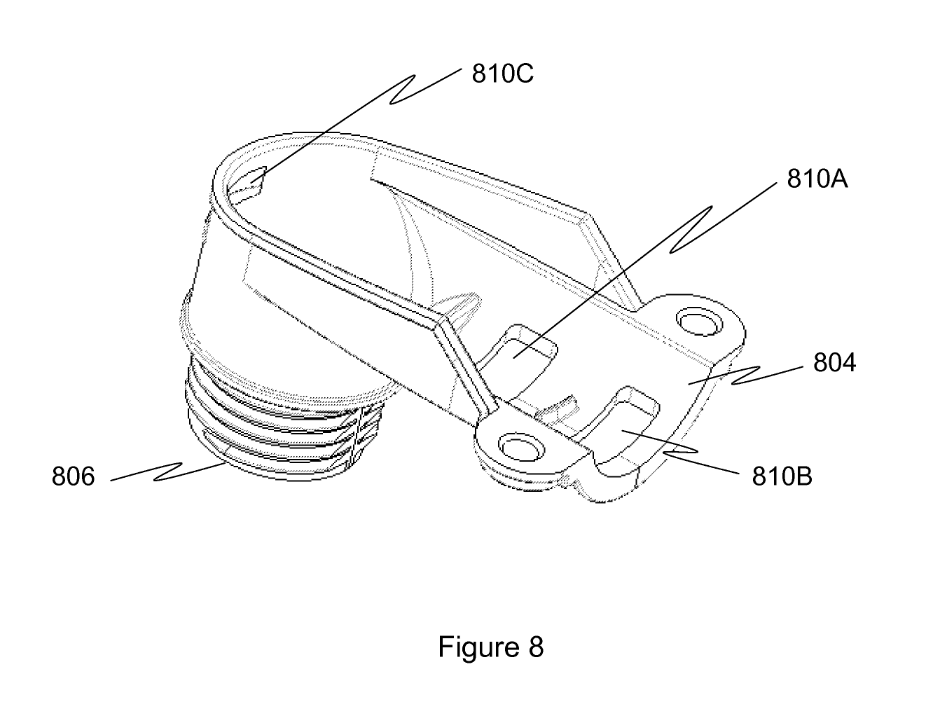

FIG. 8 illustrates an exemplary schematic of a fitting used to couple conduit to junction box, according to yet alternative embodiment of the present invention. In this embodiment, the fitting facilitates angular (e.g., rectangular) coupling. As shown therein, the fitting in this embodiment comprises a metallic housing with clamp fit arrangement at one end (804) and locknut arrangement at the other end (806). Moreover, a plurality of apertures (810A, 810B, 810C etc.) are provided in wall of the metallic housing.

The fittings according to the present invention, for example, as illustrated in FIGS. 4, 5, 6, 7 and 8 provide several advantages and/or benefits over conventional fittings. For example, by virtue of the plurality of apertures, the fittings of the present invention save on the quantity of metal required to make the fittings. This facilitates reducing cost and also results in saving of valuable natural resources. For example, the fittings are often made from zinc or aluminum. The provision of apertures reduces amount of zinc or aluminum required to make the fittings. Other metals/metallic compositions may also be used to make the fittings consistent with the present invention.

The apertures also enable the operator to view portions of the conduits inserted into the fitting. This way the operator can more easily ensure that the conduits are inserted completely (e.g., up to the conduit stop diameter) into the fitting thereby ensuring high quality fit.

Moreover, with apertures on the surface of the fitting, the operator can grip the fitting more easily, e.g., when it has to be rotated over the conduit. The improved grip enhances efficiency of the coupling task.

In various embodiments, the apertures provided in the body of the fitting can be of various shapes, sizes and positions. The specific configurations of apertures illustrated in FIGS. 4, 5, 6, 7 and 8 are exemplary rather than limiting. Preferably, the configuration of apertures should be such that the fitting still complies with applicable standards, for example, Underwriters Laboratories (UL), Canadian Standards Association (CSA) etc.

In an embodiment, the present invention provides a method for coupling conduit to another conduit or to junction box, using fitting comprising plurality of apertures in its wall. The method comprises inserting the conduit into one end of the fitting. The method also comprises inserting another conduit into another end of the fitting or inserting another end of the fitting into junction box aperture, depending upon embodiment. Depending upon embodiments, the method includes tightening set-screw over the inserted conduit, fixing clamp on the inserted conduit, fixing locknut on the threaded end of the fitting etc.

The fitting of the present invention is characterized as metallic in the specific embodiments. It can be made entirely from single metal, from an alloy, or from a composition which primarily contains metal ingredients.

Accordingly, the present invention provides improved techniques for coupling electrical conduits. It is understood that the examples and embodiments described herein are for illustrative purposes only and that various modifications or changes in light thereof will be suggested to persons of ordinary skill in the art and are to be included within the spirit and purview of this application.

What is claimed is:

1. An apparatus for coupling electrical conduits, the apparatus comprising:
a hollow cylindrical metallic housing;
a plurality of apertures passing through curved cylindrical surface of the housing; and
a first holding arrangement at a first end and a second holding arrangement at a second end of the housing.

2. The apparatus of claim 1 wherein inner diameter of the first end of the housing is dimensioned to receive an electrical conduit.

3. The apparatus of claim 2 wherein the electrical conduit being an electrical metallic tubing (EMT) or a flexible metallic conduit (FMC).

4. The apparatus of claim 1 wherein inner diameter of the second end of the housing is dimensioned to receive an electrical conduit.

5. The apparatus of claim 4 wherein the electrical conduit being an electrical metallic tubing (EMT) or a flexible metallic conduit (FMC).

6. The apparatus of claim 1 wherein the plurality of apertures are configured so that proportion of total area of the plurality of apertures to total area of outer metallic surface of the housing is about 40:60.

7. The apparatus of claim 1 wherein the plurality of apertures are configured to reduce outer metallic surface area of the housing by about 10 to 60%.

8. The apparatus of claim 1 wherein the plurality of apertures are so configured to reduce weight of the housing by about 40% compared to no-aperture weight.

9. The apparatus of claim 1 wherein the plurality of apertures are so configured to reduce weight of the housing by about 10 to 60% compared to no-aperture weight.

10. The apparatus of claim 1 wherein one or more of the plurality of apertures are see-through apertures.

11. The apparatus of claim 1 wherein the first holding arrangement at the first end is selected from the group consisting of set-screw arrangement, thread and locknut arrangement, screw-in connection arrangement and clamp arrangement.

12. The apparatus of claim 1 wherein the second holding arrangement at the second end is selected from the group consisting of set-screw arrangement, thread and locknut arrangement, screw-in connection arrangement and clamp arrangement.

13. The apparatus of claim 1 wherein the plurality of apertures are so configured to maintain strength of the housing in accordance with at least Underwriters Laboratories (UL) standard or at least Canadian Standards Association (CSA) standard.

14. An electrical conduit fitting comprising:
a metallic housing; and
a plurality of apertures provided in wall of the metallic housing and being configured to reduce weight of the fitting by about 10 to 60% compared to no-aperture weight.

15. The electrical conduit fitting of claim 14 further comprising a holding arrangement at each extremity of the metallic housing.

16. The electrical conduit fitting of claim 15 wherein the holding arrangement at any one of the extremities is selected from the group consisting of set-screw arrangement, thread and locknut arrangement, screw-in connection arrangement and clamp arrangement.

17. An electrical conduit fitting comprising:
a metallic housing; and
a plurality of apertures provided in wall of the metallic housing to reduce mass of metal in the housing.

18. The electrical conduit fitting of claim 17 wherein the mass of metal in the housing is reduced due to the plurality of apertures by about 10 to 60% compared to no-aperture housing.

19. The electrical conduit fitting of claim 17 wherein the mass of metal in the housing is reduced due to the plurality of apertures by at least 40% compared to no-aperture housing.

20. The electrical conduit fitting of claim 17 further comprising a first holding arrangement at a first extremity and a second holding arrangement at a second extremity of the metallic housing, wherein
the first holding arrangement is selected from the group consisting of set-screw arrangement, thread and locknut arrangement, screw-in connection arrangement and clamp arrangement, and wherein,
the second holding arrangement is selected from the group consisting of set-screw arrangement, thread and locknut arrangement, screw-in connection arrangement and clamp arrangement.
